(19) United States
(12) Patent Application Publication
(10) Pub. No.: US 2019/0300383 A1
(43) Pub. Date: Oct. 3, 2019

(54) ELECTROACTIVE MATERIALS FOR LITHIUM-ION BATTERIES AND OTHER APPLICATIONS

(71) Applicant: Lionano Inc., Woburn, MA (US)

(72) Inventors: Dong Ren, Woburn, MA (US); Yun Shen, Woburn, MA (US); Yingchao Yu, Woburn, MA (US)

(73) Assignee: Lionano Inc., Woburn, MA (US)

(21) Appl. No.: 16/089,172

(22) PCT Filed: Dec. 14, 2017
(86) PCT No.: PCT/US2017/066381

§ 371 Date: Sep. 27, 2018

Related U.S. Application Data
(60) Provisional application No. 62/435,669, filed on Dec. 16, 2016.

(51) Int. Cl. C01G 53/00; H01M 4/505; H01M 4/525; H01M 10/0525; H01M 4/04

(52) U.S. Cl. CPC C01G 53/50; H01M 4/505; H01M 2004/021; H01M 10/0525; H01M 4/0471; H01M 4/525

(57) ABSTRACT

The present invention generally relates to materials for batteries and other applications. For instance, certain embodiments are directed to a positive electroactive material, e.g., for use in a lithium-ion battery. In some embodiments, the material may have the formula LiₐM_{b}[NiₓMn_{y}Co_{z}]_{1-b}O₂, where 1.00≤a<1.01, 0<b≤0.08, 0.34<x≤0.58, 0.21≤y≤0.38, and 0.21≤z≤0.38. In some cases, the material may have a D50 ranging from 4.0 to 7.8 micrometers, a tap density from 2.00 to 2.40 g/cm³, and/or a discharge capacity of ranging from 74.0% to 80.3% at a 30 C current rate (vs. the capacity obtained at 0.1 C). Methods for preparing or using the various Pt materials and formulations, as well as electrochemical cells containing the material, are also described in various embodiments. In some cases, the materials may be formed from relatively small particle sizes, which may lead to improved performance. In addition, in some cases, such materials may be able to repeatedly withstand high rate charging and discharging, without a major loss of performance.

### RELATED APPLICATIONS

This application claims the benefit of U.S. Provisional Patent Application Ser. No. 62/435,669, filed Dec. 16, 2016, entitled “Electroactive Materials for Lithium-Ion Batteries and Other Applications,” incorporated herein by reference in its entirety.

### FIELD

The present invention generally relates to materials for batteries such as lithium-ion batteries, and other applications.

### BACKGROUND

Currently, the majority of the world's energy is supplied by non-renewable sources of energy. This leaves the sustainability of our planet in a precarious position, susceptible to changes in supply of oil and the effects of global warming from greenhouse gas emissions. While worldwide energy consumption is expected to double within the next 50 years, total oil production is expected to soon plateau. Therefore, a shortage of energy supply could be imminent. There is an urgent need for breakthroughs in renewable energy generation and storage that will help to protect our environment and lessen our dependence on fossil fuels. The transportation industry has been attributed to 71% of the total petroleum consumption in the United States. As such, there has been an unprecedented effort to develop energy generation and storage technology for electric vehicles. Currently, the greatest impediment to commercial viability of electric vehicles is the limitation of the batteries used in the vehicles, which do not provide enough range or convenience to compete in a consumer market. Therefore, technological advances in lithium-ion batteries (LIBs), the most common form of energy storage in electric vehicles, are urgently needed to meet the strong demand for the electrification of transportation.

The characteristics of lithium-ion battery systems—e.g., their energy density, safety, cost—require significant improvements. A lithium-ion battery is usually composed of a negative electroactive material, a positive electroactive material, an electrolyte, and a separator. In current technology, the working voltage, capacity, and rate capability of lithium-ion batteries are mainly determined by the limited capacity and thermodynamics of the positive electroactive material. Due to this, the development of better positive electroactive materials is desirable, especially for electric vehicle applications.

Currently, there are at least four main types of positive electroactive materials being used in lithium-ion batteries: lithium cobalt oxide (LCO), lithium iron phosphate (LFP), lithium manganese oxide (LMO) and lithium nickel manganese cobalt oxide (NMC). Each material has characteristics which makes it useful in certain applications and unsuitable for certain applications. For instance, LCO positive electroactive materials have been widely used in commercial electronics, but cobalt is very expensive to be used at large scale application such as electric vehicles. LFP positive electroactive materials are safe and offer high cycle life, but have the lowest energy density. LMO electroactive materials offer high thermal stability but have relatively low capacity and suffer from manganese dissolution. NMC positive electroactive materials have been considered the best candidate for electric vehicle energy storage due to their balanced energy density, cycle life, and cost.

However, the rate capacity of today's NMC positive electroactive material is insufficient for use in electric vehicles especially for high power applications, e.g., in applications requiring relatively high charge/discharge speeds. Accordingly, improvements in such materials are needed.

### SUMMARY

The present invention generally relates to materials for batteries and other applications. In certain aspects, such materials can be used in lithium-ion batteries, or other applications. The subject matter of the present invention involves, in some cases, interrelated products, alternative solutions to a particular problem, and/or a plurality of different uses of one or more systems and/or articles.

In one aspect, the present invention is directed to a nickel/manganese/cobalt-based lithium metal complex oxide that can be used, for example, as a high power positive electroactive material in lithium-ion battery systems. This invention also pertains, in some aspects, to methods for preparing such materials, or to lithium-ion electrochemical cells or batteries, comprising such materials.

In still another aspect, the present invention is generally directed to a composition. According to one set of embodiments, the composition comprises a material having a formula LiₐM_{b}[NiₓMn_{y}Co_{z}]_{1-b}O₂, wherein M comprises one or more of Sm, La, and Zn, a is a numerical value inclusively ranging from 1.00 to 1.01, b is a numerical value inclusively ranging from 0 to 0.08, x is a numerical value inclusively ranging from 0.34 to 0.58, y is a numerical value inclusively ranging from 0.21 to 0.38, and z is a numerical value inclusively ranging from 0.21 to 0.38. In some cases, the material has an average D50 particle size of between 4 micrometers to 7.8 micrometers and/or a tap density of between 2.00 and 2.40 g/cm³.

In another set of embodiments, the composition comprises a material having a formula Liₐ[NiₓMn_{y}Co_{z}]O₂, wherein a is a numerical value inclusively ranging from 1.00 to 1.01, x is a numerical value inclusively ranging from 0.33 to 0.58, y is a numerical value inclusively ranging from 0.21 to 0.38, and z is a numerical value inclusively ranging from 0.21 to 0.38. In some cases, the material has an average D50 particle size of between 4 micrometers to 7.8 micrometers and/or a tap density of between 2.00 and 2.40 g/cm³.

According to yet another set of embodiments, the composition comprises a material having a formula Liₐ[NiₓMn_{y}Co_{z}]O₂, wherein a is a numerical value inclusively ranging from 1.00 to 1.01, x is a numerical value inclusively ranging from 0.33 to 0.58, y is a numerical value inclusively ranging from 0.21 to 0.38, and z is a numerical value inclusively ranging from 0.21 to 0.38. In some cases, the material is formed by a process comprising dissolving a nickel salt, a manganese salt, and a cobalt salt in a solvent; reacting the salts with a hydroxide at a pH of at least 10 to produce a metal precursor; mixing the metal precursor with a lithium-containing salt to form a lithium-metal precursor mixture; and calcining the lithium-metal precursor mixture.

The present invention, in yet another aspect, is generally directed to an electrochemical cell. In certain embodiments, the electrochemical cell comprises a positive electroactive material comprising a material having a formula LiₐM_{b}[NiₓMn_{y}Co_{z}]_{1-b}O₂, wherein M comprises one or more of Sm, La, and Zn, a is a numerical value inclusively ranging from 1.00 to 1.01, b is a numerical value inclusively ranging from 0 to 0.08, x is a numerical value inclusively ranging from 0.34 to 0.58, y is a numerical value inclusively ranging from 0.21 to 0.38, and z is a numerical value inclusively ranging from 0.21 to 0.38. The cell may also comprise a negative electroactive material, and a separator separating the positive electroactive material and the negative electroactive material. In certain embodiments, the electrochemical cell exhibits a capacity of at least 170 mAh/g at 0.1 C and/or a capacity of at least 130 mAh/g at 30 C.

In one set of embodiments, the electrochemical cell comprises a positive electroactive material comprising a material having a formula Liₐ[NiₓMn_{y}Co_{z}]O₂, wherein a is a numerical value inclusively ranging from 1.00 to 1.01, x is a numerical value inclusively ranging from 0.33 to 0.58, y is a numerical value inclusively ranging from 0.21 to 0.38, and z is a numerical value inclusively ranging from 0.21 to 0.38. The cell may also comprise a negative electroactive material, and a separator separating the positive electroactive material and the negative electroactive material. In some cases, the electrochemical cell exhibits a capacity of at least 170 m Ah/g at 0.1 C and/or a capacity of at least 140 m Ah/g at 30 C.

Another set of embodiments of the present invention provides a lithium-ion electrochemical cell composed of a positive electrode comprising a positive electroactive material as described herein, a lithium intercalation negative electroactive material, a suitable non-aqueous electrolyte, and a separator between the negative electroactive material and the positive electroactive material.

In addition, in certain aspects, the current subject matter includes a positive electroactive material which is a lithium nickel manganese cobalt oxide compound having an advantageously small particle size, which can result in greater capacity at a high current rate which will result in a higher power density.

In one set of embodiments, the positive electroactive material can have an electroactive composition that comprises lithium (Li), nickel (Ni), manganese (Mn), and cobalt (Co). The composition can have a formula of Liₐ[NiₓMn_{y}Co_{z}]O₂, wherein a is a numerical value in a first range between approximately 1.00 and 1.01, x is a numerical value in a second range between approximately 0.34 and 0.58, y is a numerical value in a third range between approximately 0.21 and 0.38, and z is a numerical value in a fourth range between approximately 0.21 and 0.38.

In another set of embodiments, the positive electroactive material can have an electroactive composition that comprises lithium (Li), nickel (Ni), manganese (Mn), and cobalt (Co). The positive electroactive material can further include an element M selected from samarium (Sm), lanthanum (La), zinc (Zn) or combinations thereof. In some embodiments, the composition can have a formula of LiₐM_{b}[NiₓMn_{y}Co_{z}]_{1-b}O₂ wherein a is a numerical value in a first range between approximately 1.00 and 1.01, b is a numerical value in a second range between approximately 0 and 0.08, x is a numerical value in a third range between approximately 0.34 and 0.58, y is a numerical value in a fourth range between approximately 0.21 and 0.38, and z is a numerical value in a fifth range between approximately 0.21 and 0.38.

In certain embodiments, the positive electroactive material has a particle size (D50) of from about 4.0 micrometers (μm) to about 7.8 micrometers (μm).

In certain embodiments, the positive electroactive material has a tap density from 2.00 to 2.40 g/cm³.

In certain embodiments, the positive electroactive material displayed a discharge capacity of ranging from 74.0% to 80.3% at 30 C current rate (vs. the capacity obtained at 0.1 C).

The positive electroactive material, in some embodiments, provides superior rate capability for use in a high-power lithium-ion battery, or other applications.

Methods of making or using such electroactive materials or electrochemical cells are also contemplated in various embodiments, including any of the materials or cells described herein.

In addition, in one set of embodiments, the present invention is generally directed to a method comprising discharging an electrochemical cell comprising a positive electroactive material, a negative electroactive material, and a separator separating the positive electroactive material and the negative electroactive material at a rate of no more than 0.1 C. In some cases, the electrochemical cell exhibits a capacity of at least 170 m Ah/g. In certain embodiments, the positive electroactive material comprises a material having a formula Liₐ[NiₓMn_{y}Co_{z}]O₂, wherein a is a numerical value inclusively ranging from 1.00 to 1.01, x is a numerical value inclusively ranging from 0.33 to 0.58, y is a numerical value inclusively ranging from 0.21 to 0.38, and z is a numerical value inclusively ranging from 0.21 to 0.38.

Another set of embodiments is generally directed to discharging an electrochemical cell comprising a positive electroactive material, a negative electroactive material, and a separator separating the positive electroactive material and the negative electroactive material at a rate of at least 30 C. In some cases, the electrochemical cell exhibits a capacity of at least 140 m Ah/g. In one embodiment, the positive electroactive material comprises a material having a formula Liₐ[NiₓMn_{y}Co_{z}]O₂, wherein a is a numerical value inclusively ranging from 1.00 to 1.01, x is a numerical value inclusively ranging from 0.33 to 0.58, y is a numerical value inclusively ranging from 0.21 to 0.38, and z is a numerical value inclusively ranging from 0.21 to 0.38.

In addition, one set of embodiments is directed to a synthetic preparation method for the lithium nickel manganese cobalt oxide positive electroactive material. In some embodiments, the method comprises the steps of (i) preparing a metal precursor comprised of nickel, manganese and cobalt; (ii) mixing the metal precursor with a lithium-containing salt to form a lithium-metal precursor mixture; and (iii) obtaining the positive electroactive material by calcining the lithium-metal precursor mixture. The mixture may be calcined at a temperature in the range of from about 820° C. to about 960° C. in an air atmosphere. The synthetic method is simple and scalable.

In certain embodiments, the metal precursor comprising nickel, manganese, and cobalt may be obtained through precipitation of a solution comprising salts of nickel, manganese, and cobalt dissolved in a solvent such as distilled water, methanol, ethanol, or mixtures thereof.

In certain embodiments, the metal precursor comprising nickel, manganese and cobalt may be prepared by a method comprising (i) dissolving nickel, manganese, and cobalt salts in a such solvents as distilled water, methanol, ethanol, or mixtures thereof; (ii) pumping the solution into a reactor under nitrogen atmosphere while separately, sodium hydroxide and ammonia hydroxide of a desired amount are concurrently pumped into the reactor; (iii) maintaining the pH in the range of from about 10.8 to about 12.0, and the temperature in the range of from about 55° C. to about 85° C.; and (iv) precipitating the metal precursor from the solution.

In one set of embodiments, the present invention is generally directed to a method comprising dissolving a nickel salt, a manganese salt, and a cobalt salt in a solvent; reacting the salts with a hydroxide at a pH of at least 10 to produce a metal precursor; mixing the metal precursor with a lithium-containing salt to form a lithium-metal precursor mixture; and calcining the lithium-metal precursor mixture.

In another aspect, the present invention encompasses methods of making one or more of the embodiments described herein, for example, a material for a lithium-ion battery. In still another aspect, the present invention encompasses methods of using one or more of the embodiments described herein, for example, a material for a lithium-ion battery. Still other aspects of the present invention are described in more detail below.

In addition, other advantages and novel features of the present invention will become apparent from the following detailed description of various non-limiting embodiments of the invention when considered in conjunction with the accompanying figures.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A and 1B show scanning electron microscope (SEM) images of NMC material of certain embodiments of the present invention;

FIG. 2 is an example plot of voltage vs capacity of a high power NMC material at 0.1 C charge-discharge rate, in another embodiment of the invention; and

FIG. 3 shows the discharge capacity vs. current rate of the high power NMC and commercial NMC materials at room temperature at a voltage between +2.8 and +4.45 V vs. Li⁺/Li, in accordance with yet another embodiment of the invention.

### DETAILED DESCRIPTION

The present invention generally relates to materials for batteries and other applications. For instance, certain embodiments are directed to a positive electroactive material, e.g., for use in a lithium-ion battery. In some embodiments, the material may have the formula LiₐM_{b}[NiₓMn_{y}Co_{z}]_{1-b}O₂, where 1.00≤a≤1.01, 0≤b≤0.08, 0.34≤x≤0.58, 0.21≤y≤0.38, and 0.21≤z≤0.38. In some cases, the material may have a D50 ranging from 4.0 to 7.8 micrometers, a tap density from 2.00 to 2.40 g/cm³, and/or a discharge capacity of ranging from 74.0% to 80.3% at a 30 C current rate (vs. the capacity obtained at 0.1 C). Methods for preparing or using the various materials and formulations, as well as electrochemical cells containing the material, are also described in various embodiments. In some cases, the materials may be formed from relatively small particle sizes, which may lead to improved performance. In addition, in some cases, such materials may be able to repeatedly withstand high rate charging and discharging, without a major loss of performance.

Some aspects of the present invention are generally directed to positive electroactive materials. In some cases, as discussed in more detail below, such materials may exhibit superior rate capabilities to meet the demand of fast discharging and charging (e.g., at a 20 C or a 30 C current rate). In one set of embodiments, for example, the electrode material may have a relatively small average particle size, which may facilitate rapid lithium ion intercalation, and thus, rapid charge and discharge.

Without wishing to be bound by any theory, it is believed that high electrochemical surface and short ion diffusion lengths provided by smaller particle size may contribute to the efficient surface reaction and rapid ion extraction/insertion, and then may impart high discharge rate capability to the resulting electrode materials. In general, it is believed that no other materials retain capacity at such high C rates. In addition, it is believed that such materials can provide superior rate capability because of the high electrochemical surface and/or short ion diffusion lengths provided by the smaller particle size. This may contribute to the efficient surface reaction, and/or rapid ion extraction/insertion. Accordingly, certain embodiments of the present invention are generally directed to high-performance lithium nickel manganese cobalt oxide positive electroactive materials having superior rate capabilities for use in various applications, including (but not limited to) a lithium-ion battery, especially in certain high power applications.

Certain embodiments of the present invention are generally directed to positive electroactive materials, especially NMC (nickel manganese cobalt oxide) materials. NMC positive electroactive materials are favorable for a variety of applications, such as electric vehicles, due to their balanced performance across various criteria. Currently, there are no positive electroactive materials available to address the increasing demands of electric vehicles and other high power applications. For such applications, high-power positive electroactive materials having superior rate capabilities are desired.

Accordingly, certain embodiments of the present invention are generally directed to NMC materials. In some cases, as discussed herein, such NMC materials may have relatively high electrochemical surface areas and/or short ion diffusion lengths, which may contribute to efficient surface reaction and/or rapid ion extraction/insertion. Thus, as discussed herein, certain embodiments of the present invention are generally directed to NMC materials that may impart high discharge rate capability to the resulting electrode materials.

One aspect of the invention is generally directed to certain types of NMC or nickel manganese cobalt oxide materials. It should be understood that such nickel manganese cobalt oxide materials each have a range of various amounts of each of nickel, manganese, and cobalt present within their structure; they need not be present in fixed whole-number ratios. For instance, in one set of embodiments, a positive electroactive material may have the formula Liₐ[NiₓMn_{y}Co_{z}]O₂, where 1.00≤a≤1.01, 0.34≤x≤0.58, 0.21≤y≤0.38, and 0.21≤z≤0.38 (all of these are less than or equal to); that is, a is a numerical value ranging from 1.00 to less than 1.01; x is a numerical value ranging from 0.34 to 0.58; y is a numerical value ranging from 0.21 to 0.38, and z is a numerical value ranging from 0.21 to 0.38.

In another set of embodiments, the positive electroactive material may have the formula LiₐM_{b}[NiₓMn_{y}Co_{z}]_{1-b}O₂, where 1.00≤a≤1.01, 0≤b≤0.08, 0.34≤x≤0.58, 0.21≤y≤0.38, and 0.21≤z≤0.38 (all of these are less than or equal to); that is, a is a numerical value ranging from 1.00 to less than 1.01; b is a numerical value ranging from 0 to less than 0.08; x is a numerical value ranging from 0.34 to 0.58; y is a numerical value ranging from 0.21 to 0.38, and z is a numerical value ranging from 0.21 to 0.38.

Non-limiting examples of such positive electroactive materials include Liₐ[NiₓMn_{y}Co_{1-x-y}]O₂. Some examples include a=1.01, x=0.34, y=0.33, z=0.33; a=1.00, x=0.58, y=0.21, z=0.21; a=1.00, x=0.41, y=0.38, z=0.21; a=1.01, x=0.49, y=0.26, z=0.25. Another example is LiₐM_{b}[NiₓMn_{y}Co_{z}]_{1-b}O₂. Some specific examples include a=1.01, b=0, x=0.34, y=0.33, z=0.33; a=1.00, x=0.58, b=0.04, y=0.21, z=0.21; a=1.00, b=0, x=0.41, y=0.38, z=0.21; a=1.01, b=0, x=0.49, y=0.26, z=0.25. Still other examples are discussed in detail below.

In some cases, the material may include lithium, i.e., the material is a lithium NMC material. However, other alkali metal ions may also be present in certain instances, e.g., in addition to and/or instead of lithium, for example, sodium. In some cases, at least 50%, at least 70%, at least 80%, at least 90%, at least 95%, or at least 99% (by mole) of the alkali metal ions within a NMC composition is lithium.

The material may also contain various amounts of nickel, manganese, and cobalt. These may vary independently of each other, e.g., in the formula NiₓMn_{y}Co_{z}. In some cases, the sum of x, y, and z is 1, i.e., there are no other ions present within the NMC matrix composition (other than the alkali metal ions) other than these three. Thus, z may equal (1−x−y). However, in other cases, the sum of x, y, and z may actually be less than or more than 1, e.g., from 0.8 to 1.2, from 0.9 to 1.1, from 0.95 to 1.05, or from 0.98 to 1.02. Thus, the material may be overdoped or underdoped, and/or contain other ions present in addition to nickel, manganese, and cobalt.

In one set of embodiments, the amount of nickel present (i.e., x) may be at least 0.34, at least 0.35, at least 0.4, at least 0.45, at least 0.5, or at least 0.55. In some cases, x may be no more than 0.6, no more than 0.58, no more than 0.55, no more than 0.5, no more than 0.45, no more than 0.4, no more than 0.35, or no more than 0.34. Combinations of any of these are also possible in various embodiments, e.g., x may range between 0.34 to 0.58 (all values are inclusive).

According to certain embodiments, the amount of manganese present (i.e., y) may be at least 0.2, at least 0.21, at least 0.25, at least 0.3, or at least 0.35. In some embodiments, y may be no more than 0.38, no more than 0.35, no more than 0.3, or no more than 0.25. Combinations of any of these are also possible in various embodiments, e.g., y may range between 0.21 to 0.38 (all values are inclusive).

Similarly, in certain embodiments, the amount of cobalt present (i.e., z) may be at least 0.2, at least 0.21, at least 0.25, at least 0.3, or at least 0.35. In some embodiments, z may be no more than 0.38, no more than 0.35, no more than 0.3, or no more than 0.25. Combinations of any of these are also possible in various embodiments, e.g., z may range between 0.21 to 0.38 (all values are inclusive).

In one set of embodiments, the material may contain elements such as any one two, or three of samarium (Sm), lanthanum (La), and/or zinc (Zn). However, these may not be present in all embodiments. Without wishing to be bound by any theory, it is believed that such elements may act to replace some of the NMC within the crystal structure, e.g., as in the formula LiₐM_{b}[NiₓMn_{y}Co_{z}]_{1-b}O₂, which may improve the stability of the crystal structure, and thus the high current rate capability. For instance, in such structures b may be 0 (indicating that no Sm, La, or Zn is present), orb may be at least 0.01, at least 0.02, at least 0.03, at least 0.04, at least 0.05, at least 0.06, or at least 0.07. In addition b in some embodiments may be no more than 0.08, no more than 0.07, no more than 0.06, no more than 0.05, no more than 0.04, no more than 0.03, no more than 0.02, or no more than 0.01. Combinations of any of these are also possible in certain embodiments; for instance, b may be between 0 and 0.08, between 0.01 and 0.04, between 0.03 and 0.07, etc. (all values are inclusive).

As mentioned, in some cases, more than one of Sm, La, and Zn may be present. If so, they may be present in equimolar concentrations, or they may be present in different concentrations. For instance, M_{b} may represent SmᵢLaⱼZnₖ, where the sum of i, j, and k is b. However i, j, and k may independently be the same or different from each other. In some cases, one or more of i, j, and k is 0, i.e., one or more of Sm, La, and Zn is absent. Each of i, j, and k may independently be within the ranges described above for b, e.g., such that the sum of i, j, and k is b.

In one aspect, such materials may be formed into particles, e.g., using methods such as the ones discussed herein. Without wishing to be bound by any theory, it is believed that such small particles were not previously achievable, especially at such tap densities. In most cases, NMC materials were previously formed into electroactive materials without regard for their particle sizes or size distributions. However, as discussed herein, control of the process for forming NMC particles, such as control of the pH or the reaction temperature, may facilitate the creation of particles having the characteristics described herein, e.g., by controlling the speed of growth. Thus, one set of embodiments is generally directed to electroactive materials formed as particles. The materials may include NMC materials, such as lithium NMC materials, as described herein. The particles may be relatively monodispersed, or the particles may be present in a range of sizes. The particles may also be spherical or non-spherical.

In certain cases, the particle size (or size distribution) may be determined using D50. The D50 of a plurality of particles is the particle diameter that is larger than fifty (50) percent of the total particle (often denoted as the median number or the mass-median-diameter of the particles, e.g., in a log-normal distribution). The D50 is thus a measure of the average particle diameter, as determined by mass. Equipment for determining the D50 of a sample can be readily obtained commercially, such as described in Example 3, and can include techniques such as sieving or laser light scattering. As discussed herein, the D50 can be controlled by controlling the pH or temperature during formation of the particles. It should be noted that although D50 generally refers to the average particle diameter, this does not imply that the particles necessarily must be perfectly spherical; the particles may also be non-spherical as well.

In certain cases, the D50 may be at least about 3 micrometers, at least about 3.5 micrometers, at least about 4 micrometers, at least about 4.5 micrometers, at least about 5 micrometers, at least about 5.5 micrometers, at least about 6 micrometers, at least about 6.5 micrometers, at least about 7 micrometers, at least about 7.5 micrometers, at least about 7.8 micrometers, or at least about 8 micrometers. In addition, the D50 may be no more than about 9 micrometers, no more than about 8.5 micrometers, no more than about 8 micrometers, no more than about 7.8 micrometers, no more than about 7.5 micrometers, no more than about 7 micrometers, no more than about 6.5 micrometers, no more than about 6 micrometers, no more than about 5.5 micrometers, no more than about 5 micrometers, no more than about 4.5 micrometers, or no more than about 4 micrometers. Combinations of any of these are also possible in additional environments; for instance, the D50 may be from about 4.0 micrometers to about 7.8 micrometers.

The shape/size of the particles may be determined, in accordance with certain embodiments, by measuring their tap density. The tap density is equal to the sample's mass/volume after a compaction process, typically involving tapping of the sample (for example, 3,000 times) to settle the particles. The tap density is thus a function of both the shape of the particles (how well the particles fit together into a compacted sample, despite any irregularities in shape) and the sizes of the particles (larger particles typically will not be able to pack closely together as readily, resulting in a lower tap density).

Accordingly, tap density is a practical general measure of the relative size, shape, and/or uniformity of the particles, without necessarily requiring in-depth or microscopic analysis of the particles. It should be understood that tap density is to be distinguished from techniques that involve compressing or crushing the particles (e.g., into a homogenous mass), as doing so does not preserve the shape of the particles; such techniques would be a measure of the bulk density of the material, not the density of the individual particles. In addition, it should be understood that tap density is not a straightforward function of the size of the particles, and the tap density cannot be calculated using their average diameter or D50 measurements (e.g., by assuming that the particles are perfect spheres in a face-centered cubic packing), as to do so would ignore the shape distribution and uniformity of the particles.

Mechanical tapping is typically used to determine tap density, e.g., by repeatedly raising a contained containing material and allowing it to drop, under its own mass, a specified, relatively short distance. This may be done multiple times, e.g., hundreds or thousands of times, or until no further significant changes in volume are observed (e.g., since the particles have maximally settled within the sample). In some cases, devices that rotate the material instead of tapping may be used. Standardized methods of determining tap density include, for instance, ASTM methods B527 or D4781. Equipment for determining the tap density of a sample (e.g., for automatic tapping) can be easily acquired from commercial sources; see, e.g., Example 4. Without wishing to be bound by any theory, it is believed that a greater tap density allows a larger quantity of positive electroactive material to be stored in a limited or specific volume, thereby resulting in a higher volumetric capacity or improved volumetric energy density.

In one set of embodiments, the particles have a tap density of at least 2.00 g/cm³, at least 2.10 g/cm³, at least 2.20 g/cm³, at least 2.30 g/cm³, or at least 2.40 g/cm³. In addition, the tap density may be no more than about 2.50 g/cm³, no more than about 2.40 g/cm³, no more than about 2.30 g/cm³, no more than about 2.20 g/cm³, or no more than about 2.10 g/cm³. Combinations of any of these are also possible in various embodiments; for example, the particles of the present invention may have a tap density of 2.00 to 2.40 g/cm³.

As mentioned, the materials discussed herein may possess surprisingly high capacities in certain aspects, especially when exposed to fast discharging and charging rates (e.g., rates of 20 C or higher, e.g., 30 C). This may be useful for various applications, e.g., in certain high power applications where charge/discharge speed is crucial. Without wishing to be bound by any theory, it is believed that the size and shape of the particles discussed herein (e.g., measured by D50, tap density, etc.) may facilitate rapid lithium ion intercalation, and thus, rapid charge and discharge.

“C” is a commonly-used measure of rate of charging or discharging; for example, 1 C refers to a charging current of 1 times the rated capacity of the material (e.g., within an hour). In some embodiments, the material, when used within a battery or other suitable electrochemical device, will exhibit a capacity of at least 150 mAh/g, at least 155 mAh/g, at least 160 mAh/g, at least 165 mAh/g, at least 170 mAh/g, at least 175 mAh/g, or at least 180 mAh/g at a rate of 0.1 C. In some cases, even at higher capacities, the material may exhibit surprisingly high capacities; for example, the material, when used within a battery or other suitable electrochemical device, may exhibit a capacity of at least 120 mAh/g, at least 125 mAh/g, at least 130 mAh/g, at least 135 mAh/g, at least 140 mAh/g, at least 145 mAh/g, at least 150 mAh/g, at least 155 mAh/g, or at least 160 mAh/g at a rate of 20 C, 25 C, or 30 C. In addition, in some cases, the material may exhibit a change in capacity, at rates of 20 C, 25 C, or 30 C, relative to 0.1 C, of at least 50%, at least 55%, at least 60%, at least 65%, at least 70%, at least 75%, at least 80%, or at least 85%. In some embodiments, such materials may exhibit such capacities even after repeated charging/discharging cycles, e.g., after 1, 2, 3, 5, 10, 15, 20, 30, 50, or 100 cycles.

In contrast, many prior art materials, will exhibit a change in capacity, at similar rate comparisons, of less than 30%, less than 20%, less than 10%, or even less than 5%. This comparison may be performed by initially charging and discharging different samples of materials (e.g., within a suitable electrochemical cell) at the various rates, then comparing the capacities for each; i.e., new, virgin, samples should be used for each experiment.

Certain aspects of the invention are also generally directed to techniques for making materials such as those described herein. In one example, the material may be synthesized by a method comprising the steps of preparing a metal precursor comprising nickel, manganese and cobalt, forming a lithium-metal precursor mixture by combining the metal precursor with a desired amount of a lithium source, and calcining the lithium-metal precursor mixture at an elevated temperature for a desired amount duration to obtain the positive electroactive material. As another example, a material may be prepared by dissolving a nickel salt, a manganese salt, and a cobalt salt in a solvent, reacting the salts with a hydroxide at a pH of at least 10 to produce a metal precursor, mixing the metal precursor with a lithium-containing salt to form a lithium-metal precursor mixture, and calcining the lithium-metal precursor mixture. A temperature in the range of, for example, from about 820° C. to about 960° C. and a duration in the range of, for example, from 10 to 18 hours can be used for the calcination process of the lithium-metal precursor mixture in an air atmosphere.

In yet another set of embodiments, materials such as those discussed herein may be prepared by first dissolving a nickel salt, a manganese salt, and a cobalt salt in a solvent. A wide variety of such salts may be used in various embodiments. For instance, examples of nickel salts include, but are not limited to, nickel sulfate (NiSO₄ or NiSO₄.6H₂O), nickel acetate (Ni (CH₃COO)₂), nickel chloride (NiCl₂), or nickel nitrate (Ni(NO₃)₂ or Ni(NO₃)₂.6H₂O). More than one nickel salt may also be used in some cases. Similarly, non-limiting examples of manganese salts include manganese sulfate (MnSO₄ or MnSO₄.H₂O), manganese acetate (Mn(CH₃COO)₂), manganese chloride (MnCl₂), or manganese nitrate (Mn(NO₃)₂ or Mn(NO₃)₂.4H₂O). More than one manganese salt can also be used in certain instances. Examples of cobalt salts include, but are not limited to, cobalt sulfate (CoSO₄ or CoSO₄.7H₂O), cobalt acetate (Co(CH₃COO)₂), cobalt chloride (CoCl₂), or cobalt nitrate (Co(NO₃)₂ or Co(NO₃)₂.6H₂O). More than one cobalt salt may also be used in some cases. Soluble salts of the “M” elements (e.g. Sm, La, and/or Zn) that may be used include one or more of the relative chlorides, oxalates, sulfates, nitrates, and acetic acid salts. Any combination of any of these salts and/or other salts may be used in various embodiments. The salts may be used at any suitable concentrations, e.g., from 0.1 mol/l to their respective maximum solubility levels, and the precise concentration is not important. In some embodiments, the concentrations of the metal solutions may be selected based on the desired molar ratio of Ni:Mn:Co. In addition, the salts may be dissolved in any of a variety of solvents. The solvent used to prepare the solution may be, for example, distilled water, methanol, ethanol, isopropanol, propanol, or the like. Combinations of any of these solvents may also be used in some cases.

In some cases, the salts may be reacted with a hydroxide to form a metal precursor. In some cases, the metal precursor may be prepared by co-precipitating nickel, manganese, and cobalt together, e.g., upon interacting with the hydroxide. Examples of hydroxides that may be used include, but are not limited to, sodium hydroxide, potassium hydroxide, or ammonium hydroxide. In addition, more than one hydroxide may be used in certain instances.

The pH during this reaction may be important, according to certain embodiments. Without wishing to be bound by any theory, it is believed that the pH may be used to control the creation of particles, e.g., by controlling their speed of growth. Accordingly, in some cases, a pH of at least 10 may be used, and in some cases, the pH may be at least 10.2, at least 10.5, at least 10.8, at least 11, or at least 11.5. In some cases, the pH may also be kept within certain limits, e.g., no more than 12, no more than 11.5, no more than 11, no more than 10.8, or no more than 10.5. The pH may also be kept within combinations of these, e.g., the pH may be kept during the reaction between 10.8 and 12. The pH may be controlled, for example, by controlling the amount of hydroxide added to the reaction.

In addition, in one set of embodiments, the temperature may be controlled, e.g., to control growth. In some cases, for example, the temperature of the reaction may be at least 50° C., at least 55° C., at least 60° C., at least 65° C., at least 70° C., at least 75° C., at least 80° C., at least 85° C., etc. In addition, the temperature may be controlled to be no more than 90° C., no more than 85° C., no more than 80° C., no more than 75° C., no more than 70° C., no more than 75° C., no more than 60° C., no more than 55° C., etc. Additionally, combinations of any of these are also possible in other embodiments; for instance, the temperature of the reaction may be kept between 55° C. and 85° C.

The duration may also be controlled to control growth in some embodiments. For example, the duration of the reaction may be controlled to provide for a residence time of at least 1, at least 2, at least 5, or at least 10 hours, and/or no more than 30, no more than 25, no more than 24, no more than 20, or no more than 18 hours.

In certain embodiments, the reaction may be performed with little or no access to oxygen (O₂). Thus, for instance, the reaction may be performed in a reactor containing a nitrogen atmosphere, an inert gas atmosphere (e.g., argon), etc., as well as combinations of these and/or other suitable gases that do not contain oxygen.

In certain embodiments, the amount and/or feed rate of components of the reaction, such as sodium hydroxide, ammonia hydroxide, the pH value, temperature, etc., may be monitored precisely to control the size of the metal precursor. For instance, as a non-limiting illustrative example, a solution containing suitable amounts of nickel, manganese, and cobalt salts may be added into a reactor under a nitrogen atmosphere. Concurrently, a sodium hydroxide of a desired amount (which may be used to maintain the desired pH) and ammonia hydroxide may be added to the reactor while maintaining a pH ranging from about 10.8 to about 12.0, and a temperature ranging from about 55° C. to about 85° C.

In addition, the metal precursor may be mixed with a lithium-containing salt, or other suitable lithium source, to form a lithium-metal precursor mixture. For example, the metal precursor, after precipitation, may be removed and dried (e.g., to remove excess solvent), then exposed to a suitable lithium source. Examples of lithium sources include, but are not limited to, lithium hydroxide (LiOH or LiOH.H₂O) or lithium carbonate (Li₂CO₃). More than one lithium source may also be used in some cases. In some cases, the lithium source and the metal precursor are mixed together mechanically. The amount of lithium added may be determined by the desired chemical formula of the material. However, in some cases, excess amounts of lithium and/or metal precursor may be used, e.g., to compensate for waste or other inefficiencies that may occur during formation.

The lithium-metal precursor mixture may then be heated or calcined. Such heating may be used to remove water or various impurities from the mixture to form the final composition. For instance, calcination may cause hydroxides to be removed off as water (H₂O), carbonates to be removed as CO₂, sulfates to be removed as SOₓ, nitrates to be removed as NOₓ, etc. In some embodiments, relatively high temperatures may be used, e.g., temperatures of at least 700° C., at least 720° C., at least 740° C., at least 760° C., at least 800° C., at least 820° C., at least 840° C., at least 860° C., at least 880° C., at least 900° C., etc. In addition, the temperature, in some embodiments, may be kept to no more than 1000° C., no more than 980° C., no more than 960° C., no more than 940° C., no more than 920° C., no more than 900° C., etc. Combinations of any of these are also possible in certain embodiments, e.g., between 820° C. and 960° C. In some cases, the duration of heating or calcination may be at least 1, at least 2, at least 5, or at least 10 hours, and/or no more than 30, no more than 25, no more than 24, no more than 20, or no more than 18 hours. In one set of embodiments, for instance, calcination may occur at a temperature ranging from about 820° C. to about 960° C. for a duration ranging from 10 to 18 hours. In some cases, the desired electrochemical performance of the materials may dictate calcination temperature and/or duration of their preparation. After calcination or heating, the composition may form particles, e.g., as discussed herein.

In some cases, an electrochemical cell may be produced using a material as described herein. For example, a lithium ion electrochemical cell may be prepared using a cathode comprising a positive electroactive material such as described herein, a negative electroactive material (e.g., a lithium intercalation material), a suitable electrolyte (e.g., a non-aqueous electrolyte), and a separator between the negative electroactive material and the positive electroactive material.

A variety of cathode materials may be used in an electrochemical cell, e.g., in conjunction with the electroactive materials described herein. Many such cathode materials are known to those of ordinary skill in the art, and several are readily available commercially. For example, the electroactive materials described herein may be combined with carbon black and a suitable binder to form a cathode for use in an electrochemical cell.

As a non-limiting example, in one embodiment, a cathode can be prepared using the following steps: (i) mixing 2-3 wt % polyvinylidene fluoride (PVDF) binder in N-methyl-2-pyrrolidone (NMP) to form an NMP-binder mixture; (ii) mixing the positive electroactive material with the NMP-binder mixture and carbon black to form a mixture containing 80 wt % positive electroactive material, 10 wt % carbon black and 10 wt % NMP-binder mixture (“the 80:10:10 mixture”); (iii) transferring the 80:10:10 mixture into a ball mill, and milling the mixture at 800 rpm for 30 min with ten 5 mm diameter zirconia balls to form a slurry, wherein the zirconia balls function as a medium for more effective mixing; (iv) preparing a current collector by spreading aluminum foil onto a glass plate and spraying acetone to prevent the formation of air bubbles between the glass plate and foil; (v) applying the slurry onto the aluminum foil, spreading uniformly on to the foil using a razor blade to form a coating film; and (vi) drying the coating in a vacuum at 110° C. for 12 hours to form the positive electroactive material.

Similarly, a variety of negative electroactive materials may be used, many of which can be obtained commercially. For example, graphite or lithium foil may be used in the electrochemical cell as a lithium intercalation negative electroactive material.

A variety of electrolytes may also be used in various embodiments. The electrolyte may be aqueous or non-aqueous. Non-limiting examples of suitable non-aqueous electrolytes include lithium hexafluorophosphate (LiPF₆) in ethylene carbonate (EC) and dimethyl carbonate (DMC), lithium hexafluorophosphate (LiPF₆) in ethylene carbonate (EC) and diethyl carbonate (DEC), or lithium hexafluorophosphate (LiPF₆) in ethylene carbonate (EC) and ethyl methyl carbonate (EMC).

A variety of separates can also be used in various embodiments. Examples of separators include, but are not limited to, the Celgard 2400, 2500, 2340, and 2320 models.

International Patent Application No. PCT/US16/52627, filed Sep. 20, 2016, entitled “Nickel-Based Positive Electrode Materials,” is incorporated herein by reference in its entirety. In addition, U.S. Provisional Patent Application Ser. No. 62/435,669, filed Dec. 16, 2016, entitled “Electroactive Materials for Lithium-Ion Batteries and Other Applications,” is also incorporated herein by reference in its entirety.

The following examples are intended to illustrate certain embodiments of the present invention, but do not exemplify the full scope of the invention.

### Example 1

In this example, five samples of positive electroactive materials were prepared as follows. NiSO₄.6H₂O, MnSO₄.H₂O, CoSO₄.7H₂O, and La(NO₃)₃ were each dissolved in distilled water to form a 2 mol/L mixed metal sulfate solution in the amounts listed in Table 1 corresponding to each sample.

The mixed metal sulfate solution was then slowly pumped into a reactor under nitrogen atmosphere at a temperature of 65° C. Concurrently, an 18% NH₄OH solution and a 23% NaOH solution were separately pumped into the reactor and a metal complex hydroxide was precipitated. Before and after the solution being pumped into the reactor, the pH was kept constant at 11.8. The pH, temperature, and stirring speed of the reaction mixture were carefully monitored and controlled during the process. pH was monitored using a pH meter, and controlled by adjusting the feed rate of NaOH. The temperature was controlled using a temperature controller and a heat exchanger. Stirring was controlled using a PID controller. Residual ions such as Na⁺ and SO₄²⁻/NO₃⁻ were removed from the filter through filtration (with vacuum filtration or centrifugal filtration) and washing (using distilled water).

The precipitate was then dried in a vacuum oven at 110° C. for 12 hours to obtain a metal complex hydroxide precursor composed of a solid solution of nickel, manganese, cobalt, and an M salt (La(NO₃)₃) having the composition ratio of Ni:Mn:Co:M listed in Table 1 for each of Samples 1-5.

In a mixing machine, the metal complex hydroxide precursor was then mixed thoroughly with the amount of LiOH necessary to obtain the molar ratio listed in Table 1. Finally, the mixture was calcined in air at the temperature and the duration listed in Table 1 for each sample to produce the positive electroactive material.

Table 1 lists the molar percentages of nickel, manganese, and cobalt and the molar ratio of Li/(Ni+Mn+Co+M) in the resulting positive electroactive materials, the calcination temperature (in ° C.) used to prepare Samples 1-5 and the D50, discharge capacity (mAh/g, 0.1 C and 30 C), and discharge capacity at 30 C vs. 0.1 C current rate. (See below for details regarding the D50 and discharge measurements.)

TABLE 1

| | | | | | | | | | Discharge | | Discharge |
|---|---|---|---|---|---|---|---|---|---|---|---|
| | | | | | | | | Tap | capacity | | capacity at |
| | Ni | Mn | Co | M | Molar Ratio of | Calcination | D50 | density | (mAh/g) | | 30 C vs. 0.1 C |
| Sample | (%) | (%) | (%) | (%) | Li/(Ni + Mn + Co + M) | temp (° C.) | (μm) | (g/cm³) | 0.1 C | 30 C | (%) |
| 1 | 34.2 | 32.8 | 30.0 | 3.0 | 1.01 | 960 | 5.6 | 2.24 | 170.2 | 136.7 | 80.3 |
| 2 | 40.9 | 35.9 | 21.2 | 2.0 | 1.01 | 900 | 6.2 | 2.17 | 172.5 | 130.1 | 75.4 |
| 3 | 57.0 | 21.0 | 21.0 | 1.0 | 1.00 | 840 | 7.1 | 2.10 | 179.2 | 132.6 | 74.0 |
| 4 | 49.1 | 25.5 | 24.9 | 0.5 | 1.01 | 880 | 6.1 | 2.16 | 174.8 | 134.8 | 77.1 |
| 5 | 50.6 | 22.8 | 22.8 | 3.8 | 1.00 | 860 | 7.2 | 2.12 | 174.0 | 134.5 | 77.3 |

### Example 2

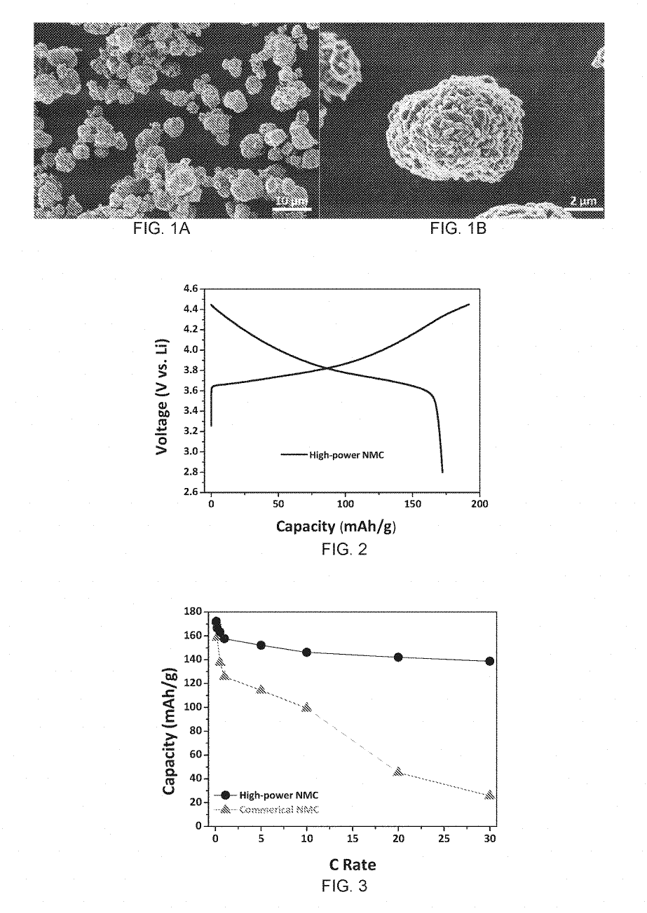

In order to illustrate the morphology of the positive electroactive material, LEO 1550 Field Emission Scanning Electron Microscopy (FESEM) (Carl Zeiss AG) images were taken of the Sample 1 electroactive material prepared in Example 1. The SEM images appear in FIG. 1.

### Example 3

A Bettersize BT-9300ST Laser Particle Size Analyzer (Bettersize instruments Ltd.) was used to measure the D50 of each of Samples 1 to 5 prepared in Example 1. The sample information and equipment parameters were set, and a suitable amount of sample was added to the disperse pool for testing. After the test was completed, the D50 for each sample was showed as the particle size of each sample. Table 1 lists the D50 for Samples 1-5. The data shows that the positive electroactive materials had a small particle size which provides high electrochemical surface and short ion diffusion lengths.

### Example 4

A Hylology HY-100 tap density analyzer was used to measure the tap density of the positive electroactive materials of Samples 1 to 5 prepared in Example 1. Approximately 10 to 20 g of each positive electroactive material was weighed to an accuracy of less than 0.0001 g. Each sample was placed in a graduated cylinder, and the cylinder was then secured in a holder. For each sample, 3000 taps (i.e., an automated lifting and dropping of the cylinder) were repeated on the sample, and the corresponding volume was measured after the taps. The tap density is equal to the sample's mass/volume after the taps. The results listed in Table 1 represent the mean of three parallel experiments performed on each sample.

### Example 5

In this example, the positive electroactive materials of Samples 1-5 prepared in Example 1 were used as the cathode in the construction of electrochemical cells. The cathode was prepared for integration in the cell as follows: (i) 2-3 wt % polyvinylidene fluoride (PVDF) binder was mixed in N-methyl-2-pyrrolidone (NMP) to form an NMP-binder mixture; (ii) the NMP-binder mixture was mixed with the positive electroactive material and carbon black to form a mixture containing 80 wt % positive electroactive material, 10 wt % carbon black and 10 wt % NMP-binder mixture (“the 80:10:10 mixture”); (iii) the 80:10:10 mixture was transferred into a ball mill, and the mixture milled at 800 rpm for 30 min with ten 5 mm diameter zirconia balls to form a slurry, where the zirconia balls function as a medium to facilitate mixing; (iv) a current collector was prepared by spreading aluminum foil onto a glass plate and spraying acetone to prevent the formation of air bubbles between the foil and the glass plate; (v) the slurry was applied onto the aluminum foil, uniformly spread on to the foil using a razor blade to form a coating film; and (vi) the coating was dried in a vacuum at 110° C. for 12 hours to form the positive electroactive material.

By combining a lithium intercalation negative electroactive material, a carbonate non-aqueous electrolyte, a separator and the positive electroactive material of each of Samples 1-4, a first set of four (4) distinct lithium ion electrochemical cells were then prepared.

A BT-2000 Arbin battery test station (Arbin Instruments) was used to charge and discharge each cell between 4.45 V and 2.8 V at room temperature with 0.1 C current rate. FIG. 2 is a plot of the voltage versus capacity for the electrochemical cell prepared with the positive electroactive material of Sample 1. In FIG. 2, the upward-sloping curve is the charging curve, showing that the cell was charged to 4.45 V; it represents the charge capacity vs. voltage. The downward-sloping curve is the discharging curve, showing that the cell was then discharge to 2.8 V after charging; it represents the discharge capacity vs. voltage. Table 1 lists the discharge capacity (mAh/g, 0.1 C) for each of the electrochemical cells prepared with Samples 1-5.

A BT-2000 Arbin battery test station (Arbin Instruments) was then used to charge and discharge a second set of electrochemical cells constructed using the material of Examples 1-4 as well as a commercial NMC sample, between 4.45 V and 2.8 V at room temperature, with different current rates (0.1 C, 0.2 C, 0.5 C, 1 C, 5 C, 10 C, 20 C and 30 C current rate, respectively; the charge rate is 1 C when discharge rate is 1 C, 5 C, 10 C, 20 C and 30 C).

Table 1 lists the capacity retention vs. 0.1 C using a discharging current of 30 C current rate for each of the electrochemical cells prepared with Samples 1-4. FIG. 3 is a plot of discharge capacity versus current rates for this high power NMC and commercial NMC materials. It will be seen that Samples 1-4 exhibited surprisingly better capacities than other, commercially-available NMC materials, especially at higher C rates; thus, it is unexpected that NMC materials could have produced such high capacities at high C rates.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the invention includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A composition, comprising:
a material having a formula LiₐM_{b}[NiₓMn_{y}Co_{z}]_{1-b}O₂, wherein:
M comprises one or more of Sm, La, and Zn,
a is a numerical value inclusively ranging from 1.00 to 1.01,
b is a numerical value inclusively ranging from 0 to 0.08,
x is a numerical value inclusively ranging from 0.34 to 0.58,
y is a numerical value inclusively ranging from 0.21 to 0.38, and
z is a numerical value inclusively ranging from 0.21 to 0.38,
the material having an average D50 particle size of between 4 micrometers to 7.8 micrometers and/or a tap density of between 2.00 and 2.40 g/cm³.

2-45. (canceled)

46. The composition of claim 1, wherein z=1−x−y.

47. The composition of claim 1, wherein x+y+z inclusively ranges from 0.98 to 1.02.

48. The composition of claim 1, wherein x inclusively ranges from 0.34 to 0.50.

49. The composition of claim 1, wherein x inclusively ranges from 0.34 to 0.45.

50. The composition of claim 1, wherein x inclusively ranges from 0.34 to 0.40

51. The composition of claim 1, wherein y inclusively ranges from 0.21 to 0.35.

52. The composition of claim 1, wherein y inclusively ranges from 0.25 to 0.35.

53. The composition of claim 1, wherein z inclusively ranges from 0.21 to 0.35.

54. The composition of claim 1, wherein z inclusively ranges from 0.25 to 0.35.

55. The composition of claim 1, wherein the D50 particle size is between 5 micrometers and 7.8 micrometers.

56. The composition of claim 1, wherein the D50 particle size is between 5 micrometers and 7.5 micrometers.

57. The composition of claim 1, wherein the tap density of between 2.10 and 2.40 g/cm³.

58. The composition of claim 1, wherein the tap density of between 2.10 and 2.30 g/cm³.

59. The composition of claim 1, wherein the material is formed by a process comprising:
dissolving a nickel salt, a manganese salt, and a cobalt salt in a solvent;
reacting the salts with a hydroxide at a pH of at least 10 to produce a metal precursor;
mixing the metal precursor with a lithium-containing salt to form a lithium-metal precursor mixture; and
calcining the lithium-metal precursor mixture.

60. A material, comprising a plurality of particles, including the composition of claim 1.

61. An electrochemical cell, comprising:
a positive electroactive material comprising the composition of claim 1;
a negative electroactive material; and
a separator separating the positive electroactive material and the negative electroactive material.

62. The electrochemical cell of claim 61, wherein the electrochemical cell is a battery.

63. The electrochemical cell of claim 61, further comprising an electrolyte in contact with the positive electroactive material and the negative electroactive material.

64. The electrochemical cell of claim 61, wherein the electrolyte is non-aqueous.
